(19) United States
(12) Patent Application Publication
(10) Pub. No.: US 2025/0145885 A1
(43) Pub. Date: May 8, 2025

(54) QUANTUM DOTS COATED WITH BLUE-LIGHT ABSORPTION LAYER AND METHOD OF FORMING THE SAME

(71) Applicant: OPULENCE OPTRONICS CO., LTD., Hsinchu City (TW)

(72) Inventors: Yuan-Chang LU, Hsinchu City (TW); Shang-Wei CHOU, Hsinchu City (TW)

(73) Assignee: OPULENCE OPTRONICS CO., LTD., Hsinchu City (TW)

(21) Appl. No.: 18/942,034

(22) Filed: Nov. 8, 2024

Related U.S. Application Data
(60) Provisional application No. 63/597,139, filed on Nov. 8, 2023.

(51) Int. Cl. C09K 11/56

(52) U.S. Cl. CPC C09K 11/565

(57) ABSTRACT

Provided is a light-emitting quantum dot coated with at least one blue-light absorption layer, including an alloy core consisting of Cd, Se, Zn, and S, at least one first shell layer which has a wurtzite structure and is coated on a surface of the alloy core; and a second shell layer consisting of ZnS and, having a zinc blende structure and is coated on a surface of the first shell layer, wherein the element ratio of each of Zn and S accounts for 30 to 50% of the overall core, and the content of Cd and Se gradually decreases outward from the core center. Also provided is a method for preparing the core-shell type light-emitting quantum dot.

### BACKGROUND

### Technical Field

The present disclosure relates to a quantum dot and a preparation method thereof, and more particularly, to a light-emitting quantum dot including at least one quaternary shell (CdZnSeS) and one outer shell (ZnS) and a preparation method thereof.

### Description of the Related Art

Quantum dots are nano-sized particles. Due to their size being smaller than twice the Bohr exciton radius of an electron, quantum confinement occurs, forming a discontinuous energy band. Accordingly, the quantum dot has the characteristic of spontaneous fluorescence after being stimulated. Such light and electrical characteristics caused by the special effect allow quantum dot materials to be widely applied in many fields of light-emitting diodes, solar cells, photodetectors, liquid crystal displays, color enhancement films, color filters, and so on.

The existing quantum dot materials, however, have problems such as insufficient color purity and luminous efficiency due to the difficulty in controlling their dimensional uniformity. Furthermore, the existing quantum dots have insufficient resistance to temperature and insufficient water and oxygen barrier properties, which affect the stability of the applied device and limit the promotion and application of such materials.

Therefore, there lies a need for a light-emitting quantum dot with high luminous efficiency, high color purity, good barrier property for water as well as oxygen, and good temperature resistance.

### SUMMARY

The present disclosure provides a core-shell type light-emitting quantum dot comprising: an alloy core that consists of Cd, Se, Zn, and S, wherein an element ratio of Zn and S each accounts for 30% to 50% of the overall core, and a content of Cd and Se gradually decreases outward from the core center; at least one first shell layer which has a wurtzite structure and is coated on a surface of the alloy core; and a second shell layer consisting of ZnS and, having a zinc blende structure and coated on a surface of the first shell layer.

In an embodiment of the present disclosure, a D90 particle size of the light-emitting quantum dot is 16 to 18 nm, and the alloy core has a radius of 3 nm or less.

In an embodiment of the present disclosure, the at least one first shell layer consists of Cd, Se, Zn, and S. In another embodiment of the present disclosure, a molar ratio of Cd:Se:Zn:S in the at least one first shell layer is from 1:20:6:3 to 1.2:28:12:6.

In an embodiment of the present disclosure, a molar ratio of Cd:Se:Zn:S in the light-emitting quantum dot is from 0.03:1:1:1 to 0.05:1.1:1.1:1.3. In another embodiment of the present disclosure, a molar ratio of Zn:S:Se in the light-emitting quantum dot is from 0.9:0.9:1 to 1.2:1.5:1.

In an embodiment of the present disclosure, the light-emitting quantum dot has an element ratio of Zn and Se each accounting for 25% to 40%, an element ratio of S accounting for 30% to 50%, and an element ratio of Cd accounting for 0.3% to 5% of the core-shell type light-emitting quantum dot. In this embodiment, the light-emitting quantum dot has an element ratio of Cd accounting for 0.3% to 3% of the core-shell type light-emitting quantum dot.

In an embodiment of the present disclosure, an element ratio of Cd and Se each accounts for 3% to 10% of the overall core.

The present disclosure further provides a method for preparing the core-shell type light-emitting quantum dot of claim 1, comprising: providing a first metal precursor solution containing a Cd metal precursor and a Zn metal precursor and activated by a reactive amine; mixing and reacting a first ion stock solution containing S ions and Se ions with the activated metal precursor solution containing the Cd metal precursor and the Zn metal precursor to obtain a solution containing an alloy core; adding a second metal precursor solution containing a Cd metal precursor and a Zn metal precursor to the solution containing the alloy core coated with the first shell layer; adding a second ion stock solution containing Se ions to the solution containing the alloy core and the second metal precursor solution at a temperature of from 270° C. to 310° C. for 10 to 30 minutes for conducting a reaction of forming a first shell layer having a wurtzite structure coated on a surface of the alloy core; adding a third ion stock solution containing S ions to the solution containing the alloy core coated with the first shell layer at a temperature of from 240° C. to 290° C. for 15 to 20 minutes for forming a first growth of ZnS shell; adding respectively a zinc salt and a fourth ion stock solution containing S ions to the solution containing the third ion stock solution at a temperature of from 240° C. to 290° C. for 15 to 30 minutes for forming a second growth of ZnS shell; and adding dodecanethiol to the solution containing the fourth ion stock solution to form a second shell layer coated on a surface of the first shell layer.

In an embodiment of the method of the present disclosure, the activated first metal precursor solution containing the Cd metal precursor and the Zn metal precursor is prepared by a process comprising activating the Cd metal precursor by the reactive amine and a reactive acid.

In an embodiment of the method of the present disclosure, the method further comprises providing a first metal precursor solution containing the Cd metal precursor, wherein the Cd metal precursor is activated in the first metal precursor solution containing the Cd metal precursor by the reactive amine and the reactive acid; and adding the Zn metal precursor to the activated first metal precursor solution containing the Cd metal precursor to activate the Zn metal precursor at a temperature of from 300° C. to 320° C.

In an embodiment of the method of the present disclosure, the method further comprises providing the first metal precursor solution containing the Cd metal precursor and the Zn metal precursor, wherein the Cd metal precursor is activated in the first metal precursor solution containing the Cd metal precursor and the Zn metal precursor by the reactive amine and the reactive acid; and heating the activated first metal precursor solution containing the Cd metal precursor and the Zn metal precursor to a temperature of from 300° C. to 320° C. to activate the Zn metal precursor.

In an embodiment of the method of the present disclosure, the reactive acid is oleic acid, the reactive amine is a primary amine, and wherein the reactive amine and the reactive acid have a molar ratio of from 1:15 to 1:25.

In an embodiment of the method of the present disclosure, the method further comprises activating the Cd metal precursor and the Zn metal precursor in the second metal precursor solution by heating to a temperature of from 180° C. to 240° C. for 10 to 30 minutes, and the second metal precursor solution further contains oleic acid, and the Cd metal precursor and the Zn metal precursor are dissolved in oleic acid.

In an embodiment of the method of the present disclosure, the activated second metal precursor solution is heated to a temperature of 270° C. to 310° C. before mixing the third ion stock solution.

In an embodiment of the method of the present disclosure, a nitrogen purge process utilizing N2 is performed during the activation of the Cd metal precursor and the Zn metal precursor.

In an embodiment of the method of the present disclosure, the primary amine is selected from a group consisting of oleylamine, hexaadecanamine, pentadecylamine, and dodecylamine.

In an embodiment of the method of the present disclosure, the alloy core is obtained at a reaction temperature of from 280° C. to 310° C. for 10 to 20 minutes.

In an embodiment of the method of the present disclosure, the zinc salt is zinc oleate.

In an embodiment of the method of the present disclosure, the Cd metal precursor is at least one selected from CdO and Cd(ac)2.

In an embodiment of the method of the present disclosure, the Zn metal precursor is at least one selected from ZnO and Zn(ac)2.

Based on the preparation method of the present disclosure, the preparation method described in the present disclosure may provide huge size core-shell type light-emitting quantum dots with at least one first shell layer having a wurtzite structure and consisting of Cd, Se, Zn, and S, and with a second shell layer consisting of ZnS which has a zinc blende structure, thereby increasing the radiative rate constant and improving the photoluminescence intensity.

### BRIEF DESCRIPTION OF THE DRAWINGS

The embodiments of the present disclosure are described by way of examples with reference to the accompanying drawings:

FIG. 1A is a schematic diagram of the structure of the core-shell type light-emitting quantum dot of the present disclosure

FIG. 1B shows the QY measurement of the core-shell type light-emitting quantum dots (A05 QDs).

FIG. 2A shows an image of the core-shell type light-emitting quantum dots (A05 QDs), which is observed by a transmission electron microscope (TEM).

FIG. 2B shows an image of the core-shell type light-emitting quantum dots (A05 QDs), which is observed by a high-resolution transmission electron microscope (HRTEM).

FIG. 3 is a diagram showing the particle size distribution of the core-shell type light-emitting quantum dots (A05 QDs).

FIG. 4 is a diagram showing elements of sulfur, zinc, selenium, and cadmium in the overall core-shell type light-emitting quantum dots (A05 QDs), which are analyzed by an energy-dispersive X-ray spectroscopy (EDS).

FIG. 5 shows an X-ray diffraction (XRD) pattern of the core-shell type light-emitting quantum dot (A05 QDs), which are analyzed by X-ray diffractometry.

FIG. 6 shows line scanning of the core-shell type light-emitting quantum dot (A05), and a diagram of elemental mapping analyzed by energy dispersive spectroscopy (EDS).

FIG. 7 is a diagram showing the photoluminescence decay curves of thin shell QDs, thick shell QDs and A05 QDs and their corresponding fittings in the solution state, which are analyzed by time-correlated single-photon counting (TCSPC).

### DETAILED DESCRIPTION OF THE PREFERRED EMBODIMENTS

The following is a description of specific embodiments for the present disclosure. Those skilled in the art can easily understand the advantages and effects of the present disclosure from the content disclosed in this specification. The present disclosure can also be implemented or applied by other different embodiments, and various details in this specification can also be given different modifications and changes based on different viewpoints and applications, without departing from the spirit disclosed by the present disclosure. In addition, all ranges and values herein are inclusive and combinable. Any value or point that falls within the range described herein. For example, any integer can be used as the minimum or maximum value to derive the subrange.

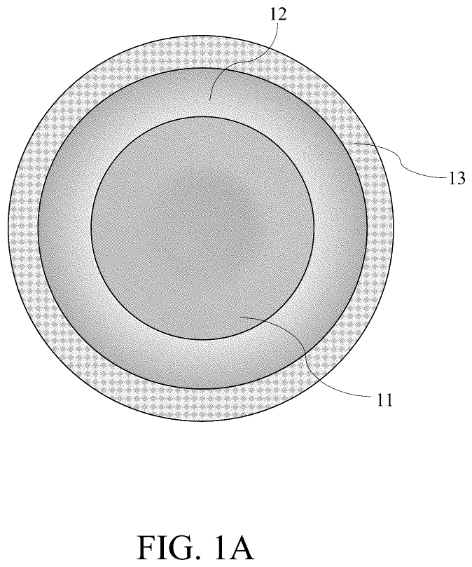

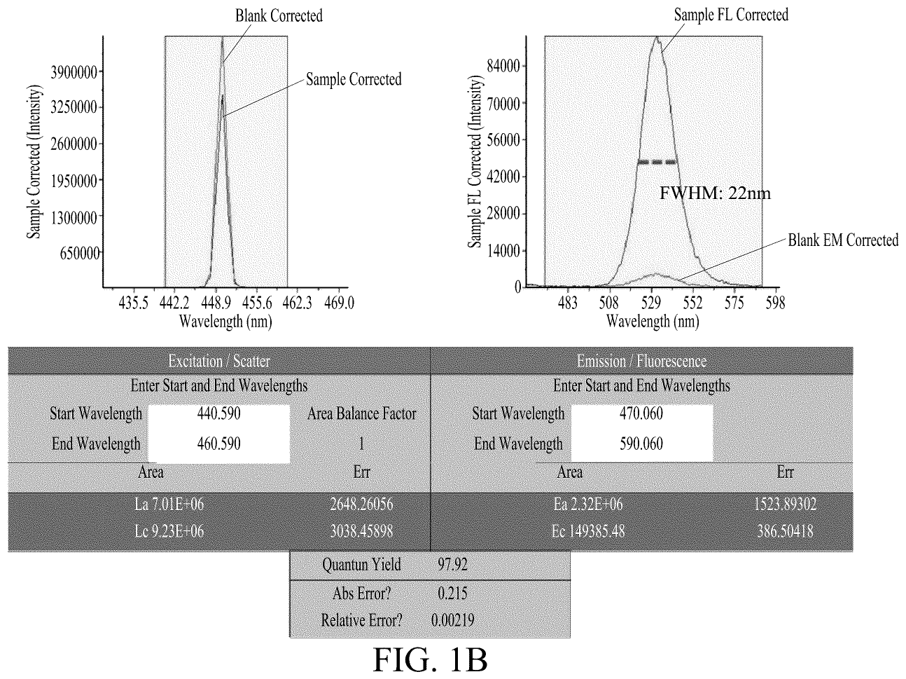

Referring to FIG. 1A, which is a schematic diagram of the structure of the core-shell type light-emitting quantum dot of the present disclosure. The light-emitting quantum dot 1 includes: an alloy core 11 consisting of Cd, Se, Zn, and S and having an element ratio of Zn and S each accounting for 30% to 50% of the alloy core 11, with a content of Cd and Se gradually decreasing outward from a center of the alloy core 11; at least one first shell layer 12 which has a wurtzite structure and is coated on a surface of the alloy core 11; and a second shell layer 13 consisting of ZnS which has a zinc blende structure and is coated on a surface of the first shell layer 12.

In an embodiment of the method of the present disclosure, the core-shell type light-emitting quantum dot has a D90 particle size of from 16 to 18 nm, such as 16, 17 or 18 nm, and the alloy core has a radius of 3 nm or less.

In an embodiment of the method of the present disclosure, the at least one first shell layer consists of Cd, Se, Zn, and S.

In an embodiment of the method of the present disclosure, the core-shell type light-emitting quantum dot has an element ratio of Zn and Se each accounting for 25% to 40% of the core-shell type light-emitting quantum dot such as 25, 30, 35 or 40%, an element ratio of S accounting for 30% to 50% of the core-shell type light-emitting quantum dot such as 30, 35, 40, 45 or 50%, and an element ration of Cd accounting for 0.3% to 5% of the core-shell type light-emitting quantum dot such as 0.3, 0.4, 0.5, 0.6, 0.7, 0.8, 0.9, 1, 2, 3, 4 or 5%.

In an embodiment of the method of the present disclosure, the core-shell type light-emitting quantum dot has an element ratio of Cd and Se each accounting for 3% to 10% of the alloy core such as 3, 4, 5, 6, 7, 8, 9 or 10%.

In order to obtain the core-shell type light-emitting quantum dot, the present disclosure provides a method for preparing the core-shell type light-emitting quantum dot of claim 1, comprising: providing a first metal precursor solution containing a Cd metal precursor and a Zn metal precursor and activated by a reactive amine; mixing and reacting a first ion stock solution containing S ions and Se ions with the activated metal precursor solution containing the Cd metal precursor and the Zn metal precursor to obtain a solution containing an alloy core; adding a second metal precursor solution containing a Cd metal precursor and a Zn metal precursor to the solution containing the alloy core coated with the first shell layer; adding a second ion stock solution containing Se ions to the solution containing the alloy core and the second metal precursor solution at a temperature of from 270° C. to 310° C. for 10 to 30 minutes for conducting a reaction of forming a first shell layer having a wurtzite structure coated on a surface of the alloy core; adding a third ion stock solution containing S ions to the solution containing the alloy core coated with the first shell layer at a temperature of from 240° C. to 290° C. for 15 to 20 minutes for forming a first growth of ZnS shell; adding respectively a zinc salt and a fourth ion stock solution containing S ions to the solution containing the third ion stock solution at a temperature of from 240° C. to 290° C. for 15 to 30 minutes for forming a second growth of ZnS shell; and adding dodecanethiol to the solution containing the fourth ion stock solution to form a second shell layer coated on a surface of the first shell layer.

In an embodiment of the method of the present disclosure, the Cd metal precursor is at least one selected from CdO and Cd(ac)2.

In an embodiment of the method of the present disclosure, the Zn metal precursor is at least one selected from ZnO and Zn(ac)2.

In an embodiment of the method of the present disclosure, the temperature for the reaction of forming a first shell layer having a wurtzite structure coated on a surface of the alloy core is 270, 275, 280, 285, 290, 295, 300, 305 or 310° C. and the reaction time forming a first shell layer having a wurtzite structure coated on a surface of the alloy core is 10, 15, 20, 25 or 30 minutes.

In an embodiment of the method of the present disclosure, the third ion stock solution containing S ions is added to the solution containing the alloy core coated with the first shell layer at a 240, 245, 250, 255, 260, 265, 270, 275, 280, 285 or 290° C., and a reaction proceeds 15, 16, 17, 18, 19 or 20 minutes for a first growth of ZnS shell.

In an embodiment of the method of the present disclosure, the zinc salt and a fourth ion stock solution containing S ions are added respectively to the solution containing the third ion stock solution at a temperature of from 240, 245, 250, 255, 260, 265, 270, 275, 280, 285 or 290, and a reaction proceeds 15, 16, 17, 18, 19, 20, 21, 22, 23, 24, 25, 26, 27, 28, 29 or 30 minutes for a second growth of ZnS shell.

In an embodiment of the method of the present disclosure, the activated first metal precursor solution containing the Cd metal precursor and the Zn metal precursor is prepared by a process comprising activating the Cd metal precursor by the reactive amine and a reactive acid.

In an embodiment of the method of the present disclosure, the method further comprises providing a first metal precursor solution containing the Cd metal precursor, wherein the Cd metal precursor is activated in the first metal precursor solution containing the Cd metal precursor by the reactive amine and the reactive acid; and adding the Zn metal precursor to the activated first metal precursor solution containing the Cd metal precursor to activate the Zn metal precursor at a temperature of from 300° C. to 320° C. such as 300, 305, 310, 315 or 320° C.

In an embodiment of the method of the present disclosure, the method further comprises providing the first metal precursor solution containing the Cd metal precursor and the Zn metal precursor, wherein the Cd metal precursor is activated in the first metal precursor solution containing the Cd metal precursor and the Zn metal precursor by the reactive amine and the reactive acid; and heating the activated first metal precursor solution containing the Cd metal precursor and the Zn metal precursor to a temperature of from 300° C. to 320° C., such as 300, 305, 310, 315 or 320° C., to activate the Zn metal precursor.

In an embodiment of the method of the present disclosure, the reactive acid is oleic acid, the reactive amine is a primary amine, and the reactive amine and the reactive acid have a molar ratio of from 1:15 to 1:25. For example, the molar ratio is 1:15, 1:16, 1:17, 1:18, 1:19, 1:20, 1:21, 1:22, 1:23, 1:24, or 1:25.

In an embodiment of the method of the present disclosure, the method further comprises activating the Cd metal precursor and the Zn metal precursor in the second metal precursor solution by heating to a temperature of from 180° C. to 240° C. for 10 to 30 minutes, and the second metal precursor solution further contains oleic acid, and the Cd metal precursor and the Zn metal precursor are dissolved in oleic acid. In an embodiment of the method of the present disclosure, the Cd metal precursor and the Zn metal precursor in the second metal precursor solution are activated at a temperature of from 180, 185, 190, 195, 200, 205, 210, 215, 220, 225, 230, 235 or 240° C. for 10, 15, 20, 25 or 30 minutes

In an embodiment of the method of the present disclosure, the activated second metal precursor solution is heated to a temperature of 270° C. to 310° C. such as 270, 275, 280, 285, 290, 295, 300, 305, 310° C. before mixing the third ion stock solution.

In an embodiment of the method of the present disclosure, a nitrogen purge process utilizing N₂ is performed during the activation of the Cd metal precursor and the Zn metal precursor.

In an embodiment of the method of the present disclosure, the primary amine is selected from a group consisting of oleylamine, hexaadecanamine, pentadecylamine, and dodecylamine.

In an embodiment of the method of the present disclosure, the alloy core is obtained by mixing and reacting the first ion stock solution containing S ions and Se ions with the activated metal precursor solution containing the Cd metal precursor and the Zn metal precursor at a reaction temperature of from 280° C. to 310° C. for 10 to 20 minutes. For example, the temperature is 280, 285, 290, 295, 300, 305, 310° C., and the reaction time is 10, 11, 12, 13, 14, 15, 16, 17, 18, 19 or 20 minutes.

In an embodiment of the method of the present disclosure, the zinc salt is zinc oleate.

The details will be illustrated more specifically further through the following examples. However, the interpretation of the present disclosure should not be construed as limiting that of the following examples.

### Comparative Example 1: Preparation of Thin Shell Quantum Dots (QDs)

### Preparation of CdSe Core

0.4 mmol of stearic acid and 0.2 mmol of CdO were mixed in a 25 mL three-neck flask and heated to 220° C. under N₂ gas. Then, the colorless mixture was cooled to room temperature. 2 mmol of octadecylamine (ODA) and 8 ml of 1-octadecene (ODE) were sequentially added into the flask, and the mixture was heated to 270° C. under N₂ gas. As soon as the heating mantle was removed, 2 ml of Se-trioctylphosphine (TOP) (1 M) and 4 ml of ODE were sequentially injected. The reaction solution was rapidly cooled to 60° C. within 10 or 15 seconds. The nanocrystals were purified by a typical hexane/methanol extraction procedure. The obtained green-emitting CdSe cores were dispersed in hexane.

### Preparation of Shell

The TOP-assisted successive ionic layer adsorption and reaction (TOP-SILAR) procedure was used for core/shell QDs synthesis.

The green-emitting CdSe cores dissolved in 2.5 mL of hexanes were mixed with 0.8 g of ODA and 4.0 mL of ODE in a 25-mL three-neck flask. The flask was pumped down to remove hexanes with a mechanical pump at room temperature for 30 min, followed by removing any residual air from the system at 100° C. for another 10 min. Subsequently, the system was switched to N₂ gas and the reaction mixture was heated to 140° C. for injection.

0.4 mL of TOP solution was injected as an activator, and the reaction mixture was further maintained at 200° C. for 30 min. After the activation, 0.33 mL of Zn injection solution (0.1 mol/L) was injected and maintained at 200° C. for 20 min. For the growth of the ZnS shell, without further purification, the temperature was decreased from 200° C. to 180° C. Then 0.33 mL of S precursor solution was consecutively added via syringe to the reaction flask. The temperature was increased immediately to 220° C. for 60 min to allow in-situ growth of the first ZnS shell layer, and then decreased to 140° C.

After 0.4 mL of fresh TOP solution was injected, the temperature was immediately increased to 180° C. The Zn and S precursor solutions (0.46 mL each) were consecutively added via syringe to the reaction flask at the interval of 10 min for the growth of the second ZnS shell layer. Repeat injection and growth to form more ZnS shell layers as appropriate. The reaction was terminated by allowing the reaction mixture to cool to room temperature. The final product was diluted by hexanes followed by a methanol extraction. The extraction procedure was repeated three times, and the outermost hexane layer was stored.

### Comparative Example 2: Preparation of Thick Shell QDs

A mixture of 0.14 mmol of CdO powder, 3.14 mmol of ZnO powder, 7 mL of oleic acid (OA) and 15 mL of ODE was mixed in a 50 mL three-neck flask under nitrogen gas, heated to 210° C., and degassed for 10 min. Then, the temperature of the reaction mixture was raised to 310° C. At this temperature, a stock solution of Se (1.5 mmol) and S (2.5 mmol) in TOP (3 mL) was immediately added into the reaction mixture. The reaction temperature was kept at 310° C. for 10 min to form the quarternary CdSeZnS alloyed core QDs. The heating mantle was removed, and the reaction mixture was cooled to room temperature in a water bath and then diluted with hexane and excess anhydrous ethanol to remove excess ligands and precursors by centrifugation. For fabrication of CdSeZnS alloy core/ZnS thick shell QDs, S-ODE (prepared by dissolving 1.6 mmol of S in 2.4 ml of ODE) stock solution was continuously injected at 310° C. for 12 min to the above reaction solution without centrifugation after 10 min of reaction. Zn acetate dihydrate (3 mmol) was dissolved in OA+ODE mixed solution to form a clear stock solution. After injecting the solution, the reaction temperature was lowered to 270° C. Then, S-TOP solution (9 mmol) was added dropwise for 10 min. The reaction temperature was maintained at the injection temperature for 20 min. The amount of Zn and S was varied to obtain the outer ZnS-shell thickness.

### Example 1: Preparation of the Core-Shell QDs (A05 QDs)

### Preparation of CdSeZnS Alloy Core

CdO as Cd precursor (0.14 mmole) was reacted in the presence of OA (22 mmole), Hexadecanamine (1 mmole) and octadecene (15 ml) to provide a reaction mixture. Cd precursor was transformed to activated Cd ions at a high temperature of 150˜180° C.

ZnO as Zn precursor (2.9 mmole) was added into the reaction mixture, and then the reaction mixture was heated to a temperature of 300˜320° C. Zn precursor was transformed to activated Zn ions for the formation of alloy cores.

An anion stock solution containing selenium (Se, 1.52 mmole), Sulfur (S, 2.5 mmole), and TOP (6.7 mmole) was added into the above-mentioned reaction mixture at 280˜310° C.

After 10 min, CdSeZnS alloy cores was formed.

### Preparation of First Shell—Quaternary CdSeZnS Alloy Shell

Cd precursor (0.65 mmole) and Zn precursor (5.4 mmole) were dissolved in OA (I1 mmole) at 180˜240° C. under N₂ purge for 10˜20 min. This mixture was added into the solution of alloy cores and thereby heated to 270˜320° C.

An anion stock solution containing selenium (Se, 24 mmole) and TOP (53 mmole) was then added into the above-mentioned mixture at 270˜320° C. and reacted for 10˜30 min.

Further, another anion stock solution containing S (2 mmole), and TOP (2.2 mmole) was added into the above-mentioned mixture and reacted at 240˜270° C. for 15˜20 min. A CdSeZnS alloy shell was formed on the CdSeZnS alloy cores.

### Preparation of Second Shell—ZnS Shell

Zn precursor (3 mmole) was added into OA (10 mmole) and then was heated up to 180˜240° C. under N₂ purge for 10˜20 min. When the mixture became a clear and light yellow liquid, the complex of Zn-oleate was formed.

Afterward, the complex of Zn-oleate was added into the solution containing the QDs having CdSeZnS alloy core/quaternary CdSeZnS alloy shell at 270˜310° C.

Then, the dodecanethiol (17 mmole) was added into this solution at 270˜310° C. for 10˜30 min.

The formed product was the core-shell type light-emitting quantum dots having CdSeZnS alloy core/first quaternary CdSeZnS alloy shell/second ZnS shell (hereinafter, A05 QDs), which had the alloy core with ultra large size (16˜18 nm) and the double-layer shell with a wurtzite structure. As shown in FIG. 1B, the quantum yield (QY) of A05 QDs is higher than 95%, reaching almost 98%.

### Test Example 1: Analysis of QDs

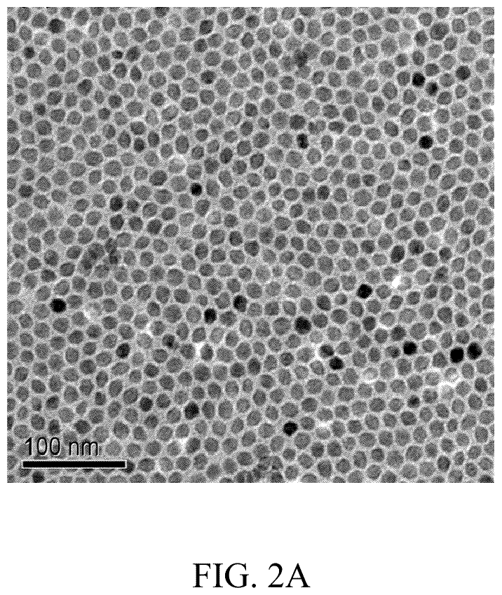

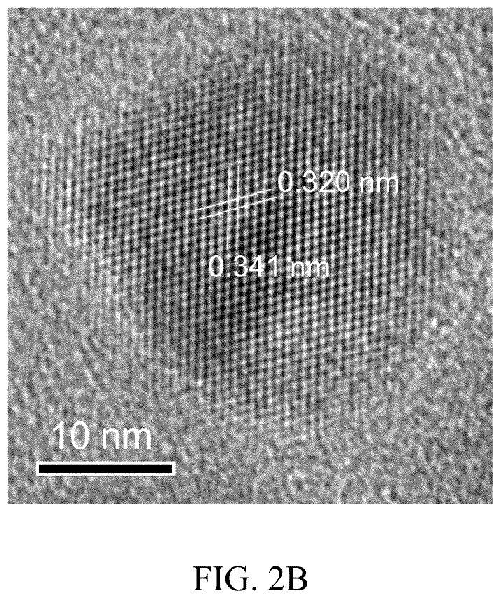

A05 QDs having a structure of CdZnSeS core/first CdZnSeS shell/second ZnS shell were observed through transmission electron microscope (TEM) and high-resolution transmission electron microscope (HRTEM). As shown in FIG. 2A, the appearance of A05 QDs was in an irregular shape. As shown in FIG. 2B, A05 QDs had a wurtzite structure.

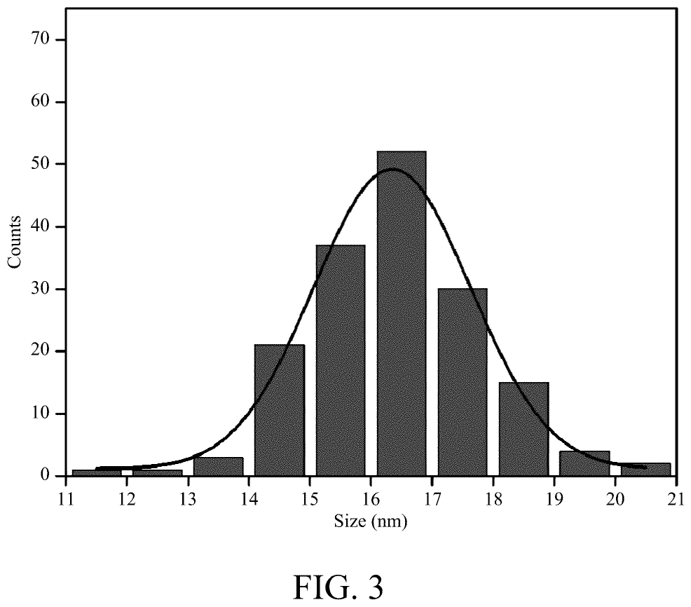

The particle size analyzer was also used to analyze A05 QDs. As shown in FIG. 3, the D90 particle size of A05 QDs was 16.34 nm, and the standard deviation of the average particle size was 1.52 nm.

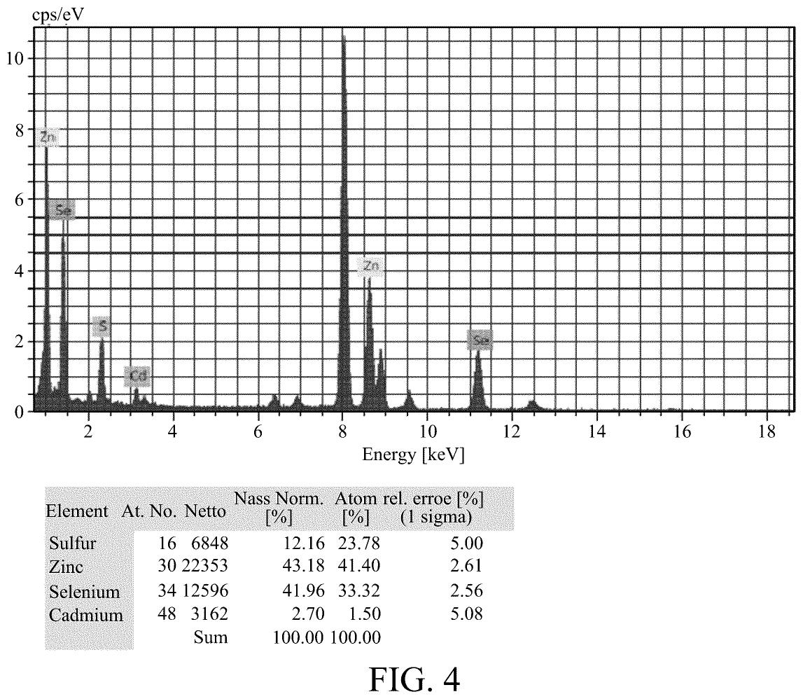

FIG. 4 showed the element composition of A05 QDs through energy-dispersive X-ray spectroscopy (EDS).

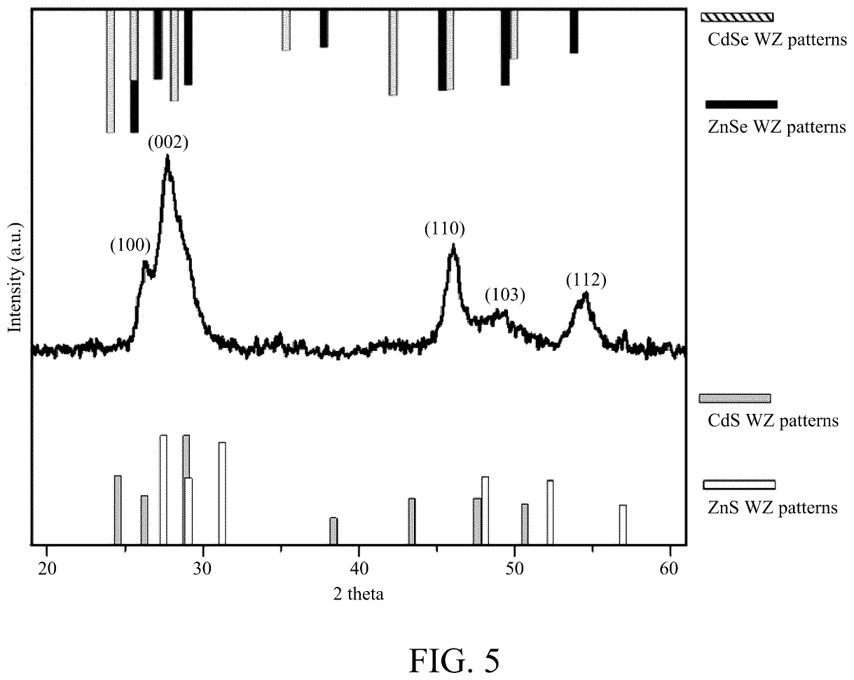

A05 QDs were analyzed by X-ray diffractometry (XRD). As shown in FIG. 5 accompanied by FIG. 2B, A05 QDs had a wurtzite structure. It can be seen that in the XRD pattern, the position of characteristic signals of A05 QDs is close to the position of reference wurtzite signals of ZnSe, compared with that of CdS and ZnS, so it is concluded that A05 QDs have higher Zn and Se contents.

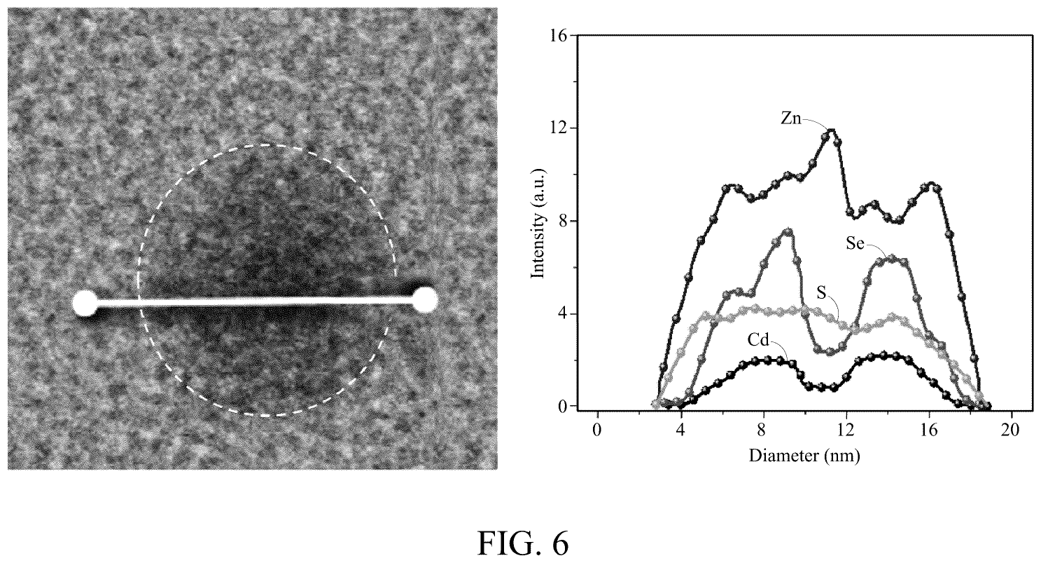

A line scanning of A05 QDs was performed by energy dispersive spectroscopy (EDS). As shown in FIG. 6, the second shell layer consisting of ZnS was indeed formed on the first shell layer consisting of Cd, Se, Zn, and S.

Time-resolved fluorescence spectra was measured using time-correlated single-photon counting (TCSPC) to record the change in fluorescence from the beginning of luminescence to dissipation after being excited by a single photon. The results of TCSPC were used to calculate the lifetime of the excitation light. By substituting the quantum efficiency (QY) value and lifetime value into a formula, the radiative rate constant (kᵣ) and non-radiative rate constant (kₙᵣ) can be derived.

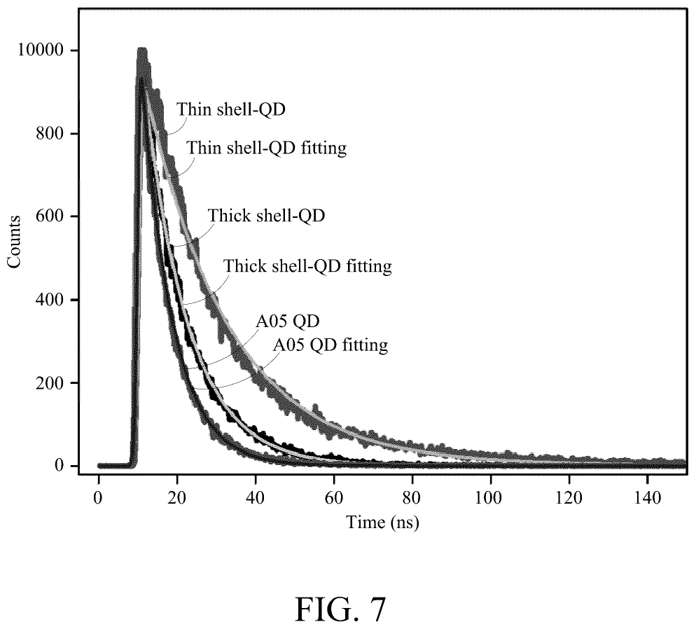

Since the outer surface of the CdSeZnS alloy core is directly coated with the CdSeZnS alloy shell layer before covering the outermost ZnS shell layer, the CdSeZnS shell greatly reduce lattice mismatch and surface defects, allowing the improvement of excitation energy to be released in the form of a large amount of light. As shown in Table 1 and FIG. 7, the radiative rate constant (kᵣ) of A05 QDs is greater than thick shell QDs and thin shell QDs, and A05 QDs have the fastest lifetime.

TABLE 1
Lifetime, quantum efficiency, radiative rate constant
(kᵣ) and non-radiative rate constant (kₙᵣ) of thin
shell QDs, thick shell QDs and A05 QDs.

| Sample | Lifetime (ns) | QY % | kᵣ | kₙᵣ |
|---|---|---|---|---|
| Thin shell QDs | 21.16 | 94 | 4.45 × 10⁷ | 2.84 × 10⁶ |
| Thick shell QDs | 11.14 | 97 | 8.71 × 10⁷ | 2.69 × 10⁶ |
| A05 QDs | 7.77 | 98 | 12.6 × 10⁷ | 2.57 × 10⁶ |

### Test Example 2: Analysis of Optic Films

The photoluminescence intensity of the optic films prepared from the thick shell QDs according to Comparative Example 2 and from the A05 QDs according to Example 1 are determined. The preparation method of the optic film can refer to US20210382208A1, TW201634954A and TW201704445A, whose entire contents are incorporated herein by reference. As shown in Table 2, the photoluminescence intensity of the A05 QDs optic film is greater than that of the thick shell QD optic film.

TABLE 2
Photoluminescence intensity and chromaticity coordinates (x, y)
of the A05 QDs optic film and the thick shell QDs optic film.

| | | QD | Thickness | Photoluminescence | | |
|---|---|---|---|---|---|---|
| No. | Item | per. | (μm) | intensity | x | y |
| 1 | Thick shell | 5 | 200 | 1569.7 | 0.1696 | 0.1768 |
| | QDs | | | | | |
| 2 | A05 QDs | 5 | 200 | 2396.2 | 0.1673 | 0.2500 |

The above embodiments are merely illustrative and are not intended to limit the present disclosure. Those skilled in the art can modify and change the above embodiments without departing from the spirit and scope of the present disclosure. Therefore, the scope of the present disclosure is defined by the claims attached to the present disclosure. As long as the effect and implementation purpose of the present disclosure is not affected, it should be covered in this disclosed technical content.

What is claimed is:

1. A core-shell type light-emitting quantum dot, comprising:
an alloy core consisting of Cd, Se, Zn, and S and having an element ratio of Zn and S each accounting for 30% to 50% of the alloy core, with a content of Cd and Se gradually decreasing outward from a center of the alloy core;
at least one first shell layer which has a wurtzite structure and is coated on a surface of the alloy core; and
a second shell layer consisting of ZnS and, having a zinc blende structure and is coated on a surface of the first shell layer.

2. The core-shell type light-emitting quantum dot of claim 1, which has a D90 particle size of from 16 to 18 nm, wherein the alloy core has a radius of 3 nm or less.

3. The core-shell type light-emitting quantum dot of claim 1, wherein the at least one first shell layer consists of Cd, Se, Zn, and S.

4. The core-shell type light-emitting quantum dot of claim 1, which has an element ratio of Zn and Se each accounting for 25% to 40% of the core-shell type light-emitting quantum dot, an element ratio of S accounting for 30% to 50% of the core-shell type light-emitting quantum dot, and an element ration of Cd accounting for 0.3% to 5% of the core-shell type light-emitting quantum dot.

5. The core-shell type light-emitting quantum dot of claim 1, which has an element ratio of Cd and Se each accounting for 3% to 10% of the alloy core.

6. A method for preparing the core-shell type light-emitting quantum dot of claim 1, comprising:
providing a first metal precursor solution containing a Cd metal precursor and a Zn metal precursor and activated by a reactive amine;
mixing and reacting a first ion stock solution containing S ions and Se ions with the activated metal precursor solution containing the Cd metal precursor and the Zn metal precursor to obtain a solution containing an alloy core;
adding a second metal precursor solution containing a Cd metal precursor and a Zn metal precursor to the solution containing the alloy core coated with the first shell layer;
adding a second ion stock solution containing Se ions to the solution containing the alloy core and the second metal precursor solution at a temperature of from 270° C. to 310° C. for 10 to 30 minutes for conducting a reaction of forming a first shell layer having a wurtzite structure coated on a surface of the alloy core;
adding a third ion stock solution containing S ions to the solution containing the alloy core coated with the first shell layer at a temperature of from 240° C. to 290° C. for 15 to 20 minutes for forming a first growth of ZnS shell;
adding respectively a zinc salt and a fourth ion stock solution containing S ions to the solution containing the third ion stock solution at a temperature of from 240° C. to 290° C. for 15 to 30 minutes for forming a second growth of ZnS shell; and
adding dodecanethiol to the solution containing the fourth ion stock solution to form a second shell layer coated on a surface of the first shell layer.

7. The method of claim 6, wherein the activated first metal precursor solution containing the Cd metal precursor and the Zn metal precursor is prepared by a process comprising activating the Cd metal precursor by the reactive amine and a reactive acid.

8. The method of claim 7, further comprising:
providing a first metal precursor solution containing the Cd metal precursor, wherein the Cd metal precursor is activated in the first metal precursor solution containing the Cd metal precursor by the reactive amine and the reactive acid; and
adding the Zn metal precursor to the activated first metal precursor solution containing the Cd metal precursor to activate the Zn metal precursor at a temperature of from 300° C. to 320° C.

9. The method of claim 7, further comprises:
providing the first metal precursor solution containing the Cd metal precursor and the Zn metal precursor, wherein the Cd metal precursor is activated in the first metal precursor solution containing the Cd metal precursor and the Zn metal precursor by the reactive amine and the reactive acid; and
heating the activated first metal precursor solution containing the Cd metal precursor and the Zn metal precursor to a temperature of from 300° C. to 320° C. to activate the Zn metal precursor.

10. The method of claim 7, wherein the reactive acid is oleic acid, the reactive amine is a primary amine, and wherein the reactive amine and the reactive acid have a molar ratio of from 1:15 to 1:25.

11. The method of claim 6, further comprises:
activating the Cd metal precursor and the Zn metal precursor in the second metal precursor solution by heating to a temperature of from 180° C. to 240° C. for 10 to 30 minutes, and
wherein the second metal precursor solution further contains oleic acid, and the Cd metal precursor and the Zn metal precursor are dissolved in oleic acid.

12. The method of claim 11, wherein the activated second metal precursor solution is heated to a temperature of 270° C. to 310° C. before mixing the third ion stock solution.

13. The method of claim 11, wherein a nitrogen purge process utilizing N₂ is performed during the activation of the Cd metal precursor and the Zn metal precursor.

14. The method of claim 10, wherein the primary amine is selected from a group consisting of oleylamine, hexaadecanamine, pentadecylamine, and dodecylamine.

15. The method of claim 6, wherein the alloy core is obtained at a reaction temperature of from 280° C. to 310° C. for 10 to 20 minutes.

16. The method of claim 6, wherein the zinc salt is zinc oleate.

17. The method of claim 6, wherein the Cd metal precursor is at least one selected from CdO and Cd(ac)₂.

18. The method of claim 6, wherein the Zn metal precursor is at least one selected from ZnO and Zn(ac)₂.
